(19) United States
(12) Patent Application Publication
(10) Pub. No.: US 2011/0229204 A1
(43) Pub. Date: Sep. 22, 2011

(54) IMAGE FORMING APPARATUS AND CHARGING METHOD

(75) Inventor: Toshifumi WATANABE, Hoi-gun (JP)

(73) Assignee: KONICA MINOLTA BUSINESS TECHNOLOGIES, INC., Tokyo (JP)

(21) Appl. No.: 13/050,100

(22) Filed: Mar. 17, 2011

(30) Foreign Application Priority Data
Mar. 19, 2010 (JP) 2010-064310

(51) Int. Cl. G03G 15/02

(52) U.S. Cl. 399/168

(57) ABSTRACT

An image forming apparatus includes a photoreceptor, a discharging device that discharges the photoreceptor, to regard a potential of the photoreceptor as a first potential, a charging device that charges the photoreceptor by proximity discharge, to regard a potential of the photoreceptor as a second potential. The charging device charges the photoreceptor for a plurality of times when changing the potential of the photoreceptor from the first potential to the second potential, and a change amount in potential of the photoreceptor in each charge is substantially the same.

This application is based on Japanese Patent Application No. 2010-064310 filed on Mar. 19, 2010, the contents of which are incorporated herein by reference.

### BACKGROUND OF THE INVENTION

1. Field of the Invention

The present invention relates to an image forming apparatus and a charging method, and particularly relates to an image forming apparatus and a charging method in which an electrostatic latent image is formed on a peripheral surface of a photosensitive drum.

2. Description of Related Art

In an image forming apparatus, the following operations are generally performed for forming a toner image on a peripheral surface of a photosensitive drum. First, a charger charges the peripheral surface of the photosensitive drum. Next, a light scanning apparatus irradiates the peripheral surface of the photosensitive drum with a beam, to form an electrostatic latent image on the peripheral surface of the photosensitive drum. A development device then provides the peripheral surface of the photosensitive drum with toner, thereby to develop a toner image according to the electrostatic latent image.

In the image forming apparatus as thus described, there is known a roller charging system as a system for charging the peripheral surface of the photosensitive drum. In the roller charging system, a roller-like contact type charging member is brought into contact with the peripheral surface of a photosensitive drum, to charge the peripheral surface of the photosensitive drum (see Japanese Patent Application Laid-Open No. H07-43988).

However, there has been a problem with an image forming apparatus adopted with the roller charging system in that durability of the photosensitive drum tends to deteriorate. More specifically, proximity discharge occurs between the contact-type charging member and the photosensitive drum. In the proximity discharge, electrons having relatively large energy are released, thereby causing surface layer destruction in which bonding between carbon atoms of the photosensitive drum are cut off by electrons. With occurrence of the surface layer destruction, carbon atoms and oxygen atoms in the air are bonded, to produce an oxygen function. This results in deterioration in durability of the photosensitive drum.

### SUMMARY OF THE INVENTION

An image forming apparatus according to one aspect of the present invention includes: a photoreceptor; a discharging device that discharges the photoreceptor, to regard a potential of the photoreceptor as a first potential; and a charging device that charges the photoreceptor by proximity discharge, to regard a potential of the photoreceptor as a second potential, wherein the charging device charges the photoreceptor for a plurality of times when changing the potential of the photoreceptor from the first potential to the second potential, and a change amount in potential of the photoreceptor in each charge is substantially the same.

A charging method according to another aspect of the present invention is a method for charging a photoreceptor in an image forming apparatus provided with the photoreceptor includes: the steps of rotating the photoreceptor; and charging the photoreceptor for a plurality of times so that a potential of the photoreceptor changes from a first potential to a second potential, wherein a change amount in potential of the photoreceptor in each charge is substantially the same.

### BRIEF DESCRIPTION OF DRAWINGS

This and other objects and features of the present invention will be apparent from the following description with reference to the accompanying drawings, in which:

FIG. 1 is a view showing an overall configuration of an image forming apparatus according to an embodiment of the present invention;

FIG. 2 is a graph showing a test result, as well as a relation between a potential and a water contact angle;

FIG. 3 is a graph showing a test result, as well as a relation between a potential and a water contact angle;

FIG. 4 is a graph showing a change in potential of a peripheral surface of a photosensitive drum;

FIG. 5 is a flowchart showing an operation performed by a control section;

FIG. 6 is a flowchart showing an operation performed by the control section; and

FIG. 7 is a constitutional view of an image forming section having a charger according to a modified example.

### DETAILED DESCRIPTION OF PREFERRED EMBODIMENTS

### Configuration of Image Forming Apparatus

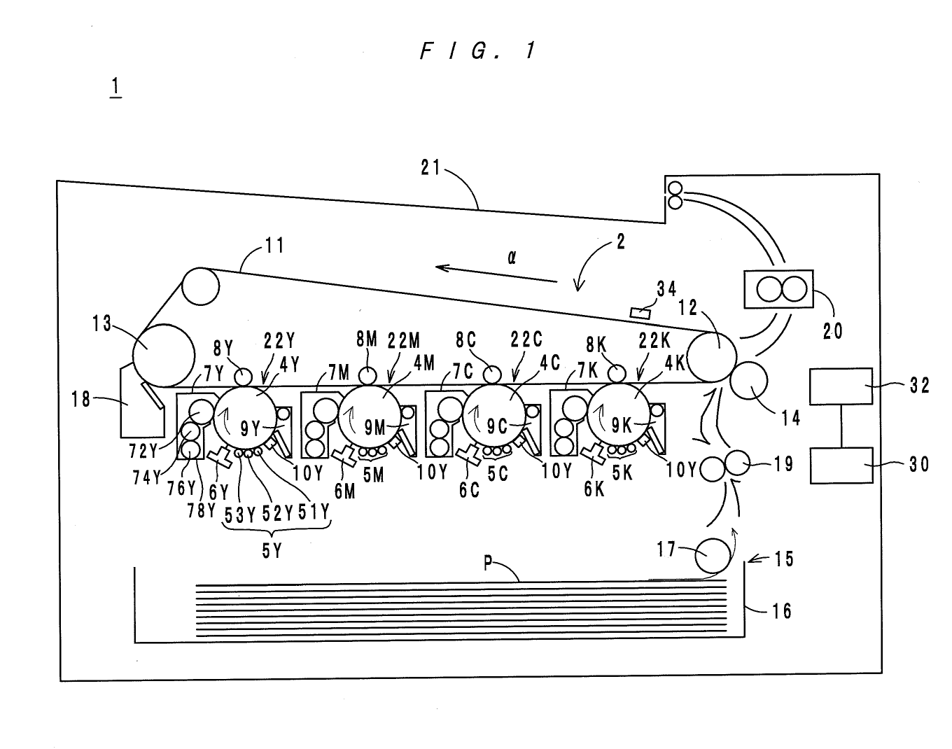

Hereinafter, an image forming apparatus and a charging method according to an embodiment of the present invention are described with reference to the drawings. FIG. 1 is a view showing an overall configuration of an image forming apparatus 1 according to the embodiment of the present invention.

An image forming apparatus 1 is an electrophotographic color printer of so-called tandem type, which is configured so as to synthesize an image of four colors [Y (yellow); M (magenta); C (cyan); K (black)]. The image forming apparatus 1 has a function of forming an image on paper (print medium) based upon image data read by a scanner, and as shown in FIG. 1, the image forming apparatus 1 includes a printing section 2, a paper feeding section 15, a timing roller couple 19, a fixing unit 20, a paper discharge tray 21, a control section 30, a storage section 32, and a sensor (sensing device) 34.

The control section 30 controls an overall operation of the image forming apparatus 1 and is, for example, realized by a CPU. The storage section 32 stores predetermined information and is realized, for example, by a memory. The paper feeding section 15 serves to feed paper P one by one, and includes a paper tray 16 and a paper feeding roller 17. In the paper tray 16, a plurality of pieces of paper P in a pre-printed state are stacked and placed. The paper feeding roller 17 takes out the paper P, placed in the paper tray 16, one by one. The timing roller couple 19 delivers the paper P, while adjusting the timing, so as to make a toner image secondarily transferred to the paper P in the printing section 2.

The printing section 2 forms a toner image on the paper P being fed from the paper feeding section 15, and includes: an image forming section 22 (22Y, 22M, 22C, 22K); a transfer section 8 (8Y, 8M, 8C, 8K); an intermediate transfer belt (image carrier) 11; a driving roller 12, a driven roller 13, a secondary transfer roller (opposed member, transfer member) 14, and a cleaning unit 18. Further, the image forming section 22 (22Y, 22M, 22C, 22K) includes: a photosensitive drum 4 (4Y, 4M, 4C, 4K), a charger 5 (5Y, 5M, 5C, 5K), an exposure unit 6 (6Y, 6M, 6C, 6K); a development unit 7 (7Y, 7M, 7C, 7K); a cleaner 9 (9Y, 9M, 9C, 9K), and an eraser 10 (10Y, 10M, 10C, 10K).

The eraser 10 discharges the peripheral surface of the photosensitive drum 4, and a potential of the peripheral surface of the photosensitive drum 4 is referred to as a residual potential Vr. The charger 5 is a charger of a roller charging system, and generates proximity discharge with the photosensitive drum 4, to charge the peripheral surface of the photosensitive drum 4 and regards a potential of the peripheral surface of the photosensitive drum 4 as a negative potential V0. The charger 5 (5Y, 5M, 5C, 5K) includes charging rollers 51 (51Y, 51M, 51C, 51K), 52 (52Y, 52M, 52C, 52K) and 53 (53Y, 53M, 53C, 53K). In FIG. 1, for the sake of simplicity of the drawing, the charging rollers 51Y, 52Y, 53Y of the charger 5Y are provided with reference numerals.

As shown in FIG. 1, the charging rollers 51, 52, 53 are arranged in this order from an upstream side to a downstream side of the rotational direction of the photosensitive drum 4, and are in contact with the peripheral surface of the photosensitive drum 4. The charging roller 51 charges the peripheral surface of the photosensitive drum 4 by proximity discharge, to change the potential of the peripheral surface of the photosensitive drum 4 from the residual potential Vr to a negative potential V1 that is lower than the residual potential Vr. The charging roller 52 charges the peripheral surface of the photosensitive drum 4 by proximity discharge, to change the potential of the peripheral surface of the photosensitive drum 4 from the potential V1 to a negative potential V2 that is lower than the potential V1. The charging roller 53 charges the peripheral surface of the photosensitive drum 4 by proximity discharge, to change the potential of the peripheral surface of the photosensitive drum 4 from the potential V2 to the negative potential V0 that is lower than the potential V2. As thus described, the charger 5 sequentially performs proximity discharge on the moving surface of the photosensitive drum 4 in order from the charging rollers 51, 52, 53, thereby to perform charge a plurality of times. It is to be noted that details on the potentials V0, V1, V2 are described later.

The exposure unit 6 applies a laser beam by control of the control section 30. A potential at a position irradiated with the laser beam is higher than the potential V0. Thereby, an electrostatic latent image is formed on the peripheral surface of the photosensitive drum 4. That is, the charger 5 and the exposure unit 6 serve as an electrostatic latent image forming device for forming an electrostatic latent image on the peripheral surface of the photosensitive drum 4.

As shown in FIG. 1, the development unit 7 (7Y, 7M, 7C, 7K) includes a development roller 72 (72Y, 72M, 72C, 72K), a feeding roller 74 (74Y, 74M, 74C, 74K), a stirring roller 76 (76Y, 76M, 76C, 76K), and a housing section 78 (78Y, 78M, 78C, 78K). In FIG. 1, for the sake of simplicity of the drawing, only the development roller 72Y, the feeding roller 74Y, the stirring roller 76Y, and the housing section 78Y of the development unit 7Y are provided with reference numerals.

The housing section 78 constitutes a body of the development unit 7, and houses toner, while storing the development roller 72, the feeding roller 74 and the stirring roller 76. The stirring roller 76 stirs the toner inside the housing section 78, to negatively charge the toner. The feeding roller 74 feeds the negatively charged toner to the development roller 72. The development roller 72 imparts the toner to the photosensitive drum 4. Specifically, a negative development bias voltage for forming a development field between the photosensitive drum 4 and the development roller 72 is applied to the development roller 72. Since the toner is negatively charged, the toner moves from the development roller 72 to the photosensitive drum 4 under the influence of the development field. Herein, the potential V0 of a portion not irradiated with a laser beam on the peripheral surface of the photosensitive drum 4 is lower than the potential of the development roller 72. On the other hand, a portion irradiated with the laser beam on the peripheral surface of the photosensitive drum 4 is higher than the potential of the development roller 72. Therefore, the toner adheres to the portion irradiated with the laser beam on the peripheral surface of the photosensitive drum 4. A toner image based upon the electrostatic latent image is thereby developed on the photosensitive drum 4.

The intermediate transfer belt 11 is extended between the driving roller 12 and the driven roller 13, and the toner image developed on the photosensitive drum 4 is primarily transferred. The transfer section 8 is arranged so as to be opposed to the inner peripheral surface of the intermediate transfer belt 11, and serves to primarily transfer the toner image formed on the photosensitive drum 4 to the intermediate transfer belt 11 by being applied with a primary transfer voltage. The cleaner 9 serves to collect the toner remaining on the peripheral surface of the photosensitive drum 4 after the primary transfer.

The driving roller 12 is rotated by an intermediate transfer belt driving section (not shown in FIG. 1), thereby to drive the intermediate transfer belt 11 in a direction of an arrow α. In this manner, the intermediate transfer belt 11 carries the toner image to the secondary transfer roller 14. Therefore, the intermediate transfer belt 11 functions as the image carrier for delivering, while carrying, the negatively charged toner image. The sensor 34 is provided so as to be opposed to the intermediate transfer belt 11, and senses a toner concentration of the intermediate transfer belt 11.

The secondary transfer roller 14 is opposed to the intermediate transfer belt 11, and forms a drum shape. Subsequently, the secondary transfer roller 14 is held at a predetermined transfer potential by being applied with a transfer voltage. Thereby, the secondary transfer roller 14 secondarily transfers the toner image, being carried by the intermediate transfer belt 11, to the paper P passing between the intermediate transfer belt 11 and the secondary transfer roller 14. More specifically, the driving roller 12 is held at a ground potential. Further, the intermediate transfer belt 11 is in contact with the driving roller 12, and is thereby held in a positive potential close to the ground potential. The transfer potential of the secondary transfer roller 14 is held so as to be higher than the potentials of the intermediate transfer belt 11 and the driving roller 12. Since the toner image is negatively charged, the toner image is transferred from the intermediate transfer belt 11 to the paper P through the electric field having occurred between the driving roller 12 and the secondary transfer roller 14.

The cleaning unit 18 removes the toner remaining on the intermediate transfer belt 11 after secondary transfer of the toner image to the paper P.

The paper P with the toner image secondarily transferred thereto is delivered to the fixing unit 20. The fixing unit 20 performs heating treatment and pressure treatment on the paper P, to thereby fix the toner image to the paper P. The printed paper P is placed in the paper discharge tray 21.

### Regarding Charger

Incidentally, the image forming apparatus 1 has a configuration for improving the durability of the photosensitive drum 4. Hereinafter, such a configuration is described with reference to the drawings.

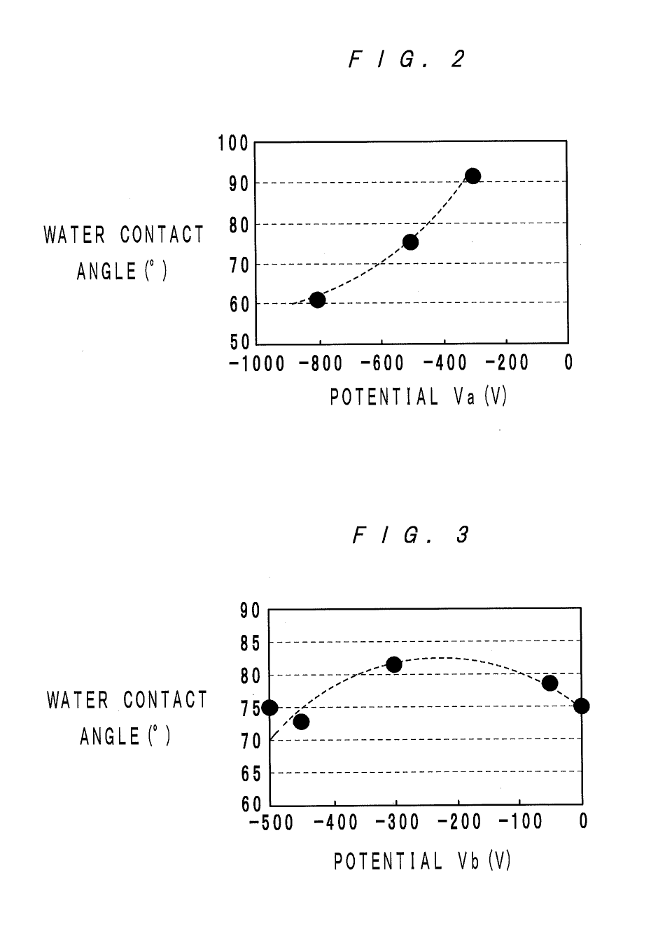

First, the present inventors performed the following test in inventing the configuration for improving the durability of the photosensitive drum 4. Specifically, a water contact angle of the peripheral surface of the photosensitive drum was measured at the time of changing the potential of the peripheral surface of the photosensitive drum from 0 V to a potential Va. The water contact angle of the peripheral surface of the photosensitive drum indicates a degree of surface layer destruction occurring on the peripheral surface of the photosensitive drum. When the surface layer destruction occurring on the peripheral surface of the photosensitive drum proceeds, the water contact angle become smaller. FIG. 2 is a graph showing a test result, as well as a relation between the potential Va and the water contact angle. A vertical axis indicates the water contact angle and a horizontal axis indicates the potential Va.

According to FIG. 2, it is found that the water contact angle becomes smaller with decrease in the potential Va, and the surface layer destruction occurring on the peripheral surface of the photosensitive drum is progressing. That is, it is found that with increase in change amount in potential of the peripheral surface of the photosensitive drum, the surface layer destruction occurring on the peripheral surface of the photosensitive drum progresses.

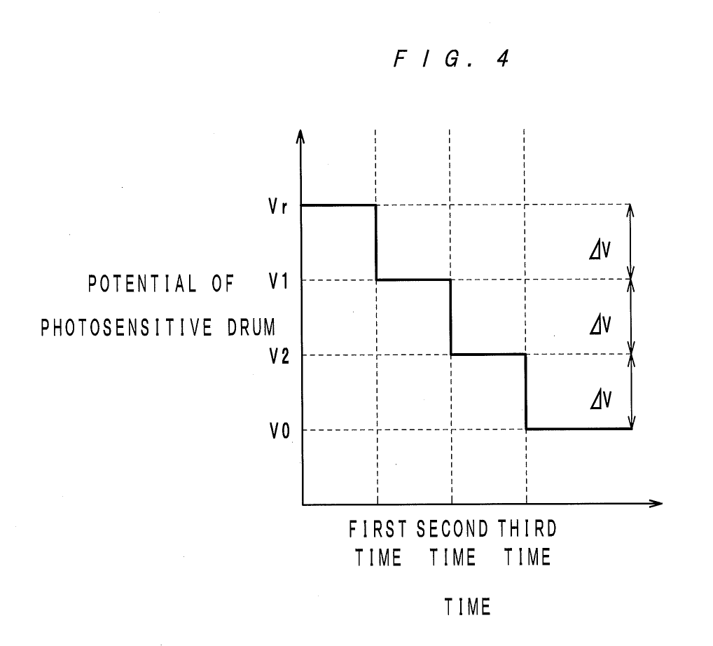

Thereat, the present inventors have come up with charging the peripheral surface of the photosensitive drum 4 over a plurality of times at the time of changing the voltage of the peripheral surface of the photosensitive drum 4 from the residual potential Vr to the potential V0. Subsequently, the present inventors performed a test described below for deciding a specific method for charging. The present inventors charged the peripheral surface of the photosensitive drum twice. In the first-time charge, the potential of the peripheral surface of the photosensitive drum was changed from 0 V to the potential Vb, and in the second-time charge, the potential of the peripheral surface of the photosensitive drum was changed from the potential Vb to −500 V. The potential Vb was then changed to 0 V, −50 V, −300 V, −450 V and −500 V, and the water contact angle of the peripheral surface of the photosensitive drum after the second-time charge was measured. FIG. 3 is a graph showing a test result, as well as a relation between the potential Vb and the water contact angle. A vertical axis indicates the water contact angle and a horizontal axis indicates the potential Vb.

According to FIG. 3, it is found that in the vicinity of Vb=−300 V, the water contact angle becomes maximum, and the progress of the surface layer destruction on the peripheral surface of the photosensitive drum has been suppressed. It is therefore found that in the case of charging the peripheral surface of the photosensitive drum over a plurality of times, the change amount in potential of the peripheral surface of the photosensitive drum in each charge is desirably made substantially the same, so as to minimize the amount of change in potential made by one charge.

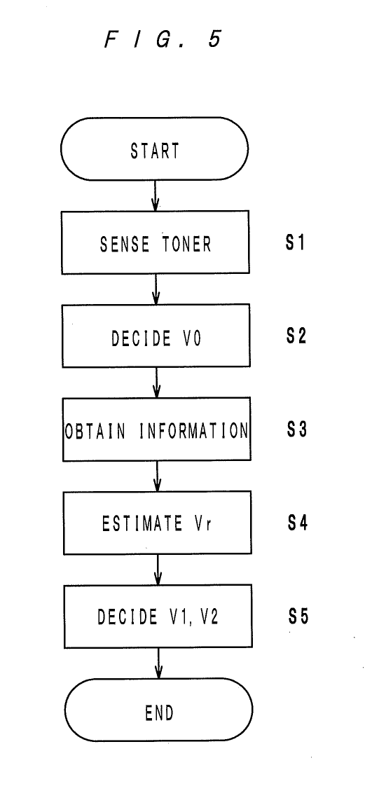

Thereat, in the image forming apparatus 1, at the time of changing the potential of the peripheral surface of the photosensitive drum 4 from the residual potential Vr to the potential V0, the charger 5 charges the peripheral surface of the photosensitive drum 4 by means of the charging rollers 51, 52, 53 for three times. Further, in the image forming apparatus 1, the change amounts in potential of the peripheral surface of the photosensitive drum 4 in charge by means of the charging rollers 51, 52, 53 are made substantially the same. Hereinafter, a detail of the charger 5 is described. FIG. 4 is a graph showing a change in potential of the peripheral surface of the photosensitive drum 4.

The charging roller 51 charges the peripheral surface of the photosensitive drum 4 by proximity discharge, to change the potential of the peripheral surface of the photosensitive drum 4 from the residual potential Vr to the negative potential V1, as seen in a first time in FIG. 4. The charging roller 52 charges the peripheral surface of the photosensitive drum 4 by proximity discharge, to change the potential of the peripheral surface of the photosensitive drum 4 from the potential V1 to the negative potential V2, as seen in a second time in FIG. 4. The charging roller 53 charges the peripheral surface of the photosensitive drum 4 by proximity discharge, to change the potential of the peripheral surface of the photosensitive drum 4 from the potential V2 to the negative potential V0, as seen in a third time in FIG. 4

Herein, the following equation (1) is established between the residual potential Vr and the potentials V0, V1, V2.

Vr−V1=V1−V2=V2−V0=ΔV (1)

That is, a change amount ΔV in potential of the peripheral surface of the photosensitive drum 4 in charge by means of the charging rollers 51, 52, 53 are the same. It should be noted that the potentials V1, V2 are expressed by the potential V0 and the residual potential Vr as in equations (2) and (3).

V1=(V0−Vr)/3+Vr (2)

V2=(V0−Vr)×2/3+Vr (3)

In the image forming apparatus 1 having the configuration as above, since the change amount in potential of the peripheral surface of the photosensitive drum 4 is substantially the same in each charge, the progress of the surface layer destruction on the peripheral surface of the photosensitive drum 4 is suppressed, as described above.

### Operation of Image Forming Apparatus

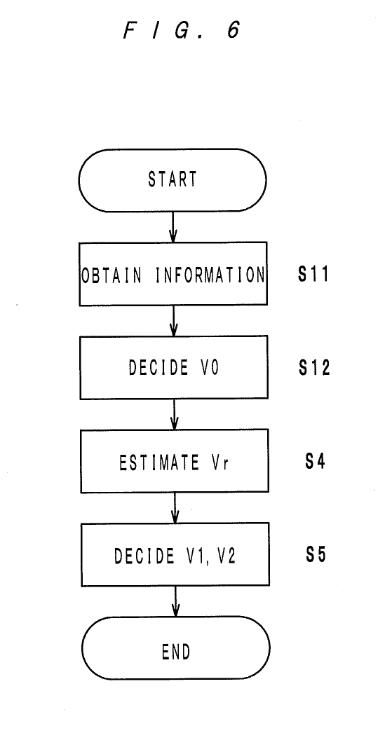

Next, the operation of the image forming apparatus 1 is described with reference to the drawings. An operation described below is an operation performed by the control section 30 to decide the potentials V0, V1, V2 before the image forming apparatus 1 executes printing of an image. FIG. 5 is a flowchart showing the operation performed by the control section 30.

The present process is started by forming test patterns as solid patterns on the peripheral surface of the intermediate transfer belt 11 with a plurality of different surface potential setting conditions.

Next, the control section 30 senses a toner concentration of each of the plurality of test patterns formed by means of the sensor 34 (step S1). Further, the control section 30 obtains a correlation between the toner concentration from the plurality of toner concentrations sensed in step S1 and the surface potential corresponding to the respective toner concentrations, to decide the target potential V0, at which a predetermined concentration can be obtained, from the correlation (step S2).

Next, the control section 30 obtains information on an ambient temperature and a humidity of the image forming apparatus 1, information on accumulated time for driving a developing unit, information on the accumulated number of rotations of a photoreceptor, and information on the transfer potential of the secondary transfer roller 14 (step S3). The control section 30 can obtain the information on the temperature and the humidity from a temperature/humidity sensor (not shown) provided in the image forming apparatus 1. Further, the control section 30 can obtain the information on the accumulated time for driving the developing unit and the information on the accumulated number of rotations of the photoreceptor, based upon the management information on the image forming apparatus 1 which is stored in the storage section 32.

Next, the control section 30 estimates the residual potential Vr based upon the information on the transfer potential (step S4). The residual potential Vr is a potential remaining on the peripheral surface of the photosensitive drum 4 after the eraser 10 has discharged the peripheral surface of the photosensitive drum 4. For this reason, the residual potential Vr changes according to the transfer potential of the image forming apparatus 1. Specifically, the residual potential Vr becomes higher with increase in the transfer potential. In the actual image forming apparatus 1, the storage section 32 stores a table showing a relation between the transfer potential and the residual potential Vr. Table 1 is a table showing the relation between the transfer potential and the residual potential Vr. The control section 30 then estimates the residual potential Vr by use of the table.

TABLE 1

| | Residual potential |
|---|---|
| Transfer voltage (V) | Vr (V) |
| not more than 800 | +60 |
| more than 800 and not more than 1000 | +90 |
| more than 1000 and not more than 1200 | +120 |
| more than 1200 and not more than 1400 | +150 |
| more than 1400 and not more than 1600 | +180 |
| more than 1600 and not more than 1800 | +210 |
| more than 1800 and not more than 2000 | +240 |
| more than 2000 and not more than 2200 | +270 |
| more than 2200 and not more than 2400 | +300 |
| more than 2400 and not more than 2600 | +330 |
| more than 2600 and not more than 2800 | +360 |
| more than 2800 and not more than 3000 | +390 |
| more than 3000 | +420 |

Next, the control section 30 decides the potentials V1, V2 from the equations (2) and (3) (step 5). With this, the process is completed.

### Effect

According to the image forming apparatus 1 as thus described, the charger 5 charges the peripheral surface of the photosensitive drum 4 for a plurality of times. The change amount in potential of the peripheral surface of the photosensitive drum 4 in each charge is substantially the same. This can minimize the amount of change in potential made by one charge. Consequently, in the image forming apparatus 1, it is possible to suppress the progress of the surface layer destruction on the peripheral surface of the photosensitive drum 4, so as to improve the durability of the photosensitive drum 4.

### Modified Example

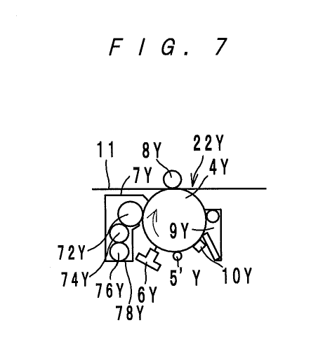

Hereinafter, a modified example of the operation of the image forming apparatus 1 is described with reference to the drawings. FIG. 6 is a flowchart showing an operation performed by the control section 30.

The present process is started with the control section 30 obtaining information on an ambient temperature and a humidity of the image forming apparatus 1, information on accumulated time for driving the developing unit, information on the accumulated number of rotations of the photoreceptor, and information on transfer potential of the secondary transfer roller 14 (step S11).

Next, the control section 30 decides the potential V0 based upon the information on the ambient temperature and the humidity, the information on the accumulated time for driving the developing unit, the information on the accumulated number of rotations of the photoreceptor which are obtained in step S11 (step S12). Subsequently, the process goes to step S4. Since steps S4 and S5 in FIG. 6 are the same as steps S4 and S5 in FIG. 5, the description thereof is not given.

As thus described, the control section 30 may decide the potential V0 based upon the information on the ambient temperature and the humidity, the information on the accumulated time for driving the developing unit and the information on the accumulated number of rotations of the photoreceptor, in place of the toner concentrations of the test patterns. Herein, upon decision of the potential V0, the control section 30 can use a table previously obtained by a test or the like and stored into the storage section 32. Examples of the table may include those shown in Tables 2 to 5. Table 2 is a table showing a relation between the accumulated time for driving the developing unit and a potential V01. Table 3 is a table showing a relation between the accumulated number of rotations of the photoreceptor and a correction amount 1 of the potential V01. Table 4 is a table showing a relation between an environmental absolute humidity and a correction amount 2 of the potential V01. Table 5 is a table showing a relation between an environmental temperature and a correction amount 3 of the potential V01.

TABLE 2

| Accumulated time (H: hours) for | V01 |
|---|---|
| driving developing unit | (V) |
| not more than 5 | −500 |
| more than 5 and not more than 10 | −500 |
| more than 10 and not more than 15 | −500 |
| more than 15 and not more than 20 | −490 |
| more than 20 and not more than 25 | −480 |
| more than 25 and not more than 30 | −470 |
| more than 30 and not more than 35 | −460 |
| more than 35 and not more than 40 | −450 |
| more than 40 and not more than 45 | −440 |
| more than 45 and not more than 50 | −430 |
| more than 50 and not more than 55 | −420 |
| more than 55 and not more than 60 | −410 |
| more than 60 and not more than 65 | −400 |
| more than 65 | −390 |

TABLE 3

| Accumulated number of rotations | Correction |
|---|---|
| (×1000 rots) | amount 1 (V) |
| not more than 100 | 0 |
| more than 100 and not more than 200 | −5 |
| more than 200 and not more than 300 | −10 |
| more than 300 and not more than 400 | −15 |
| more than 400 | −20 |

TABLE 4

| | Correction |
|---|---|
| Environmental absolute humidity (%) | amount 2 (V) |
| not more than 1.4 | −30 |
| more than 1.4 and not more than 4.5 | −30 |
| more than 4.5 and not more than 8.7 | −15 |
| more than 8.7 and not more than 13.4 | 0 |
| more than 13.4 and not more than 16.1 | +15 |
| more than 16.1 and not more than 20.6 | +30 |
| more than 20.6 and not more than 25.8 | +45 |
| more than 25.8 | +60 |

TABLE 5

| | Correction |
|---|---|
| Environmental temperature (° C.) | amount 3 (V) |
| not more than 10 | −30 |
| more than 10 and not more than 15 | −20 |
| more than 15 and not more than 20 | −10 |
| more than 20 and not more than 25 | 0 |
| more than 25 and not more than 30 | +10 |
| more than 30 and not more than 35 | +20 |
| more than 35 and not more than 40 | +30 |
| more than 40 | +40 |

Next, the control section 30 decides the potential V0 by the following equation (4), using Tables 2 to 5.

V0=V01+correction amount 1+correction amount 2+correction amount 3 (4)

Next, a modified example of the charger 5 is described with reference to the drawing. FIG. 7 is a constitutional view of the image forming section 22Y having the charger 5′Y according to the modified example.

Although the charger 5 shown in FIG. 1 was made up of the three charging rollers 51, 52, 53, a charger 5′ shown in FIG. 7 is made up of one charging roller. The charger 5′ performs three charges by one charging roller. Specifically, the charger 5′ performs one charge while the photosensitive drum 4 makes one turn, and repeats this operation three times.

It is to be noted that the number of times the chargers 5, 5′ perform the charge is not restricted to three times, but may be a plurality of times.

The present invention is useful for the image forming apparatus and the charging method, and especially excellent in being capable of improving the durability of the photosensitive drum in the image forming apparatus and the charging method where the photoreceptor is charged by proximity discharge.

Although the present invention has been described with reference to the preferred embodiments above, it is to be noted that various changes and modifications are possible to those who are skilled in the art. Such changes and modifications are to be understood as being within the scope of the present invention.

What is claimed is:

1. An image forming apparatus, comprising:
a photoreceptor;
a discharging device that discharges the photoreceptor, to regard a potential of the photoreceptor as a first potential; and
a charging device that charges the photoreceptor by proximity discharge, to regard a potential of the photoreceptor as a second potential, wherein
the charging device charges the photoreceptor for a plurality of times when changing the potential of the photoreceptor from the first potential to the second potential, and
a change amount in potential of the photoreceptor in each charge is substantially the same.

2. The image forming apparatus according to claim 1, wherein the charging device has a plurality of charging members in contact with the photoreceptor, and performs proximity discharge on a moving photoreceptor surface sequentially from the plurality of charging members, to perform charge a plurality of times.

3. The image forming apparatus according to claim 1, wherein
the photoreceptor is rotatably provided, and
the charging device performs charge once while the photoreceptor makes one turn, and performs charge over a period when the photoreceptor makes a plurality of turns.

4. A method for charging a photoreceptor in an image forming apparatus provided with the photoreceptor, comprising the steps of:
rotating the photoreceptor; and,
charging the photoreceptor for a plurality of times so that a potential of the photoreceptor changes from a first potential to a second potential:
wherein a change amount in potential of the photoreceptor in each charge is substantially the same.

5. The charging method according to claim 4, wherein charge is performed for a plurality of times while the photoreceptor makes one turn.

6. The charging method according to claim 4, wherein charge is performed once while the photoreceptor makes one turn, and charge is performed over a period when the photoreceptor makes a plurality of turns.
